(19) United States
(12) Patent Application Publication
(10) Pub. No.: US 2020/0322977 A1
(43) Pub. Date: Oct. 8, 2020

(54) USER EQUIPMENT AND COMMUNICATION METHOD

(71) Applicant: NTT DOCOMO, INC., Tokyo (JP)

(72) Inventors: Shimpei Yasukawa, Tokyo (JP); Satoshi Nagata, Tokyo (JP); Riichi Kudou, Chiyoda-Ku, Tokyo (JP)

(73) Assignees: NTT DOCOMO, INC., Tokyo (JP); NTT DOCOMO, INC., Tokyo (JP)

(21) Appl. No.: 16/303,470

(22) PCT Filed: Mar. 31, 2017
(86) PCT No.: PCT/JP2017/013592

§ 371 Date: Nov. 20, 2018

(30) Foreign Application Priority Data
May 31, 2016 (JP) 2016-109547

(51) Int. Cl. H04W 72/12; H04W 52/38

(52) U.S. Cl. CPC H04W 72/1278; H04W 92/18; H04W 52/383; H04W 72/1263

(57) ABSTRACT

User equipment of a radio communication system that supports a plurality of types of subframes that can be configured to be any of an uplink, a downlink, or a sidelink, the user equipment including an acquisition unit that acquires type information for notifying a type of a subframe; a transmitter that transmits a sidelink signal according to a transmission and reception operation corresponding to the subframe type notified via the type information when transmitting the sidelink signal; and a receiver that receives the sidelink signal according to a transmission and reception operation corresponding to the subframe type notified via the type information when receiving the sidelink signal.

### TECHNICAL FIELD

The present invention relates to user equipment and a communication method.

### BACKGROUND ART

In Long Term Evolution (LTE) or LTE successor systems (for example, also referred to as LTE Advanced (LTE-A), Future Radio Access (FRA), 4G, or the like), a Device to Device (D2D) technique for allowing user terminals to perform direct communication without going through a radio base station has been studied (for example, Non-Patent Document 1).

An interface for transmitting and receiving D2D signals between units of user equipment is referred to as a sidelink (SL: Sidelink) so as to distinguish from an uplink (UL: Uplink) and a downlink (DL: Downlink) (see Non-Patent Document 2).

D2D reduces the traffic between units of user equipment and a base station and enables communication to be performed between units of user equipment even when the base station falls into an incommunicable state in the event of a disaster or the like.

D2D is broadly classified into SL discovery (also referred to as D2D discovery) for discovering another communicable user terminal and SL communication (also referred to as D2D direct communication, D2D communication, terminal-to-terminal direct communication, or the like) for allowing direct communication to be performed between terminals. In the following description, SL communication, SL discovery, and the like are referred to simply as SL when both are not particularly distinguished from each other. Moreover, signals transmitted and received by SL are referred to as SL signals.

### PRIOR ART DOCUMENT

### Non-Patent Document

Non-Patent Document 1: “Key drivers for LTE success: Services Evolution”, September 2011, 3GPP, Internet URL:
http://www.3gpp.org/ftp/Information/presentations/pr esentations_2011/2011_09_LTE_Asia/2011 LTE-Asia_3GPP_Service_evolution.pdf
Non-Patent Document 2: 3GPP TS 36.300 V13.2.0 (2015-12)
Non-Patent Document 3: NTT Docomo “Docomo 5G White Paper,” September 2014

### SUMMARY OF THE INVENTION

### Problem to be Solved by the Invention

In 3GPP, a fifth-generation (5G) wireless technology which is a next-generation wireless communication system has been studied (see Non-Patent Document 3). In 5G, application of dynamic Time Division Duplex (TDD) that UL and DL are dynamically switched in units of TTIs is discussed. Moreover, it is discussed to freely set the use of a subframe (a DL subframe, a UL subframe, or the like) using DL control information mapped to the start of the subframe.

Here, when a SL signal and a UL/DL signal are frequency-multiplexed in the same TTI, it is expected that the influence of an ISI (Inter-Symbol Interference) and the influence of in-band emission resulting from a difference between a transmission timing of the SL signal and a transmission timing of the UL/DL signal is not negligible. Particularly, in the same TTI, when a SL signal and a DL signal are frequency-multiplexed, since the reception power level of the SL signal may be the same as or larger than the reception power level of the DL signal at a cell end, the influence of mutual interference may increase.

The disclosed technique has been developed in view of the above-described circumstance, and an object is to provide a technique capable of reducing the interference resulting from a SL signal in a wireless communication system that supports a subframe of which the use can be freely set.

### Means for Solving the Problem

User equipment of the disclosed technique is user equipment of a radio communication system that supports a plurality of types of subframes that can be configured to be any of an uplink, a downlink, or a sidelink, the user equipment including an acquisition unit that acquires type information for notifying a type of a subframe; a transmitter that transmits a sidelink signal according to a transmission and reception operation corresponding to the subframe type notified via the type information when transmitting the sidelink signal; and a receiver that receives the sidelink signal according to a transmission and reception operation corresponding to the subframe type notified via the type information when receiving the sidelink signal.

### Advantage of the Invention

According to the disclosed technology, in a radio communication system that supports a subframe that can be configured to be used for any purpose, a technique is provided that can reduce the interference caused by a SL signal.

### BRIEF DESCRIPTION OF DRAWINGS

FIG. 1 is a diagram illustrating a configuration example of a wireless communication system according to an embodiment;

FIG. 2A is a diagram illustrating an example of a sequence when a subframe type is notified from a base station to user equipment;

FIG. 2B is a diagram illustrating an example of a sequence when a subframe type is notified between units of user equipment;

FIG. 3 is a diagram illustrating an example of a physical channel configuration discussed in 5G;

FIG. 4 is a diagram illustrating a state in which a SL signal and a DL signal are frequency-multiplexed;

FIG. 5A is a diagram illustrating an example of a DL subframe;

FIG. 5B is a diagram illustrating an example of a UL subframe;

FIG. 5C is a diagram illustrating an example of a SL-dedicated subframe;

FIG. 5D is a diagram illustrating an example of a subframe in which DL and UL coexist;

FIG. 6A is a diagram illustrating a case in which the units of resources that do not transmit SL signals are REs;

FIG. 6B is a diagram illustrating a case in which the units of resources that do not transmit SL signals are symbols;

FIG. 6C is a diagram illustrating a case in which the units of resources that do not transmit SL signals are subframes;

FIG. 7A is a diagram illustrating a case in which a resource mapping configuration is notified via DL control information;

FIG. 7B is a diagram illustrating a case in which a resource mapping configuration is notified via SL control information;

FIG. 7C is a diagram illustrating a case in which a resource mapping configuration is notified via SL control information;

FIG. 8A is a diagram illustrating an example of resources that do not transmit SL signals;

FIG. 8B is a diagram illustrating an example of resources that do not transmit SL signals;

FIG. 9A is a diagram illustrating an example of a transmission timing in a DL subframe;

FIG. 9B is a diagram illustrating an example of a transmission timing in a UL subframe;

FIG. 9C is a diagram illustrating an example of a transmission timing in a SL-dedicated subframe;

FIG. 10 is a diagram illustrating a functional configuration example of user equipment according to the embodiment;

FIG. 11 is a diagram illustrating a functional configuration example of a base station according to the embodiment; and

FIG. 12 is a diagram illustrating an example of a hardware configuration of user equipment and a base station according to the embodiment.

### EMBODIMENTS OF THE INVENTION

In the following, an embodiment of the invention is described with reference to the drawings. The embodiment to be described below is an example only, and an embodiment to which the invention is applied is not limited to the following embodiment. For example, although a wireless communication system according to the present embodiment is a system of a scheme compatible with LTE, the invention is not limited to LTE but can be applied to other schemes. In the present specification and the claims, “LTE” is used in a broad sense to include 5G communication schemes corresponding to 3GPP release 10, 11, 12, 13, 14, or later as well as communication schemes corresponding to 3GPP release 8 or 9.

Although the present embodiment to be described below is described based on a physical channel configuration discussed in 5G, the present embodiment is not intended to be applied to 5G only. All or part of the present embodiment can be applied to various wireless communication systems.

In the following description, 1TTI is used to mean a minimum unit of scheduling. Moreover, although one subframe is used assuming that it has the same length as 1TTI, the subframe is not limited thereto.

“SL” is used in a broad sense to include a processing procedure in which SL signals are transmitted and received between units of user equipment UEs, a processing procedure in which a base station receives (monitors) SL signals, and a processing procedure in which user equipment UE transmits an uplink signal to a base station eNB in a RRC idle state or a state in which connection with the base station eNB is not established.

A pilot signal and a reference signal are used in the same meaning. Moreover, sidelink (SL) and D2D are used in the same meaning.

The technique according to the present embodiment can be broadly applied to general D2D. Moreover, the term “D2D” is not limited to the D2D in LTE and indicates general terminal-to-terminal communication.

<System Configuration>

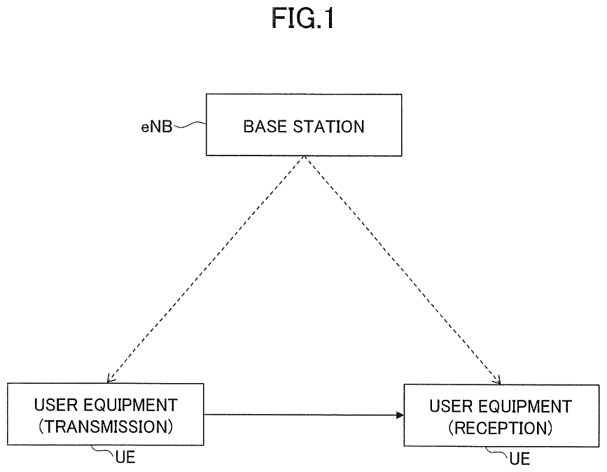

FIG. 1 is a diagram illustrating a configuration example of a wireless communication system according to an embodiment. As illustrated in FIG. 1, the wireless communication system according to the present embodiment includes a base station eNB, a transmission-side user equipment UE, and a reception-side user equipment UE. Although the transmission-side user equipment UE and the reception-side user equipment UE are distinguished in FIG. 1, the transmission-side user equipment UE and the reception-side user equipment UE have the same SL communication function (a function of transmitting and receiving SL signals).

The user equipment UE has a cellular communication function and a SL communication function. Moreover, the base station eNB has a function of outputting various instructions (SL resource allocation and the like) necessary for transmitting receiving SL signals to the user equipment UE using notification information (system information: SIB or the like), Radio Resource Control (RRC), or the like, for example.

<Processing Procedure>

(Overview)

In the present embodiment, a plurality of subframe types is defined according to the use of a subframe (for example, whether it is a DL subframe, a UL subframe, or the like), and the user equipment UE switches a transmission and reception operation when transmitting and receiving SL signals for respective subframe types. In this way, even when the SL signal and the UL/DL signal are frequency-multiplexed, it is possible to reduce interference between the SL signal and the UL/DL signal.

Here, examples of the transmission and reception operation include a SL signal resource mapping configuration, a transmission power level control method when transmitting SL signals, a SL signal transmission timing, guard time setting, selection of Modulation and Coding Scheme (MCS), and/or a SL control signal format.

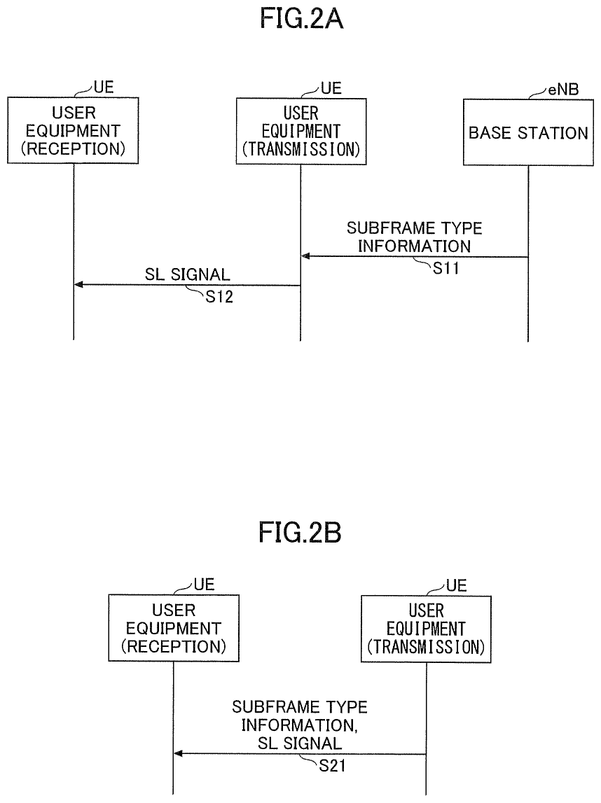

FIG. 2A illustrates an example of a sequence when a subframe type is notified from a base station eNB to user equipment UE. The base station eNB transmits subframe type information indicating a subframe type to the user equipment UE (S11). Although it is assumed that the subframe type information is transmitted via DL control information in order to enable the subframe type to be dynamically switched in units of TTIs, when the subframe type is semistatically switched, the subframe type information may be transmitted to the user equipment UE via higher-layer signaling (notification information or RRC signaling). Subsequently, when the transmission-side user equipment UE transmits a SL signal, the transmission-side user equipment UE transmits the SL signal according to a transmission and reception operation corresponding to the subframe type notified via the subframe type information (S12). When the reception-side user equipment UE receives the SL signal, the reception-side user equipment UE receives the SL signal according to a transmission and reception operation corresponding to the subframe type notified via the subframe type information.

The transmission and reception operation corresponding to the subframe type may be defined in advance as standard specifications for each subframe type, may be set to the user equipment UE via notification information or higher-layer (RRC) signaling, and may be pre-configured via a core network, SIM, or the like.

FIG. 2B illustrates an example of a sequence when a subframe type is notified from user equipment UE that transmits a SL signal to user equipment UE that receives the SL signal. When the user equipment UE transmits a SL signal according to a transmission and reception operation corresponding to the subframe type, the user equipment UE transmits the SL signal by inserting the subframe type information in the SL control information (S21). The user equipment UE receives the SL signal according to a transmission and reception operation corresponding to the subframe type notified via the subframe type information included in the SL control information.

In the present embodiment, when the subframe type information is transmitted to the reception-side user equipment UE, any of the processing procedures illustrated in FIGS. 2A and 2B may be used.

The SL control information is information which is basically transmitted from the user equipment UE. However, in the present embodiment, it may be permitted to transmit the SL control information including the subframe type information from the base station eNB to the user equipment UE. That is, the transmission-side user equipment UE in FIG. 2B may be a base station eNB. In this case, the SL control information may include an ID for specifying a cell or an ID for specifying a base station eNB (or a transmission point). In this way, a base station eNB can notify the subframe type information of the subject cell to user equipment UE present in an adjacent cell as well as user equipment UE present in the subject cell as long as the SL control information can reach the units of user equipment UEs. Moreover, the user equipment UE can recognize a transmission and reception operation in each of surrounding cells (the subject cell and the adjacent cell) by receiving the subframe type information from a plurality of base stations eNBs.

In the processing procedures illustrated in FIGS. 2A and 2B, the base station eNB may transmit the DL control information by inserting information that explicitly indicates a transmission and reception operation rather than inserting the subframe type information. Similarly, the user equipment UE (or the base station eNB) may transmit the SL control information by inserting information that explicitly indicates a transmission and reception operation rather than inserting the subframe type information. In this case, the information indicating the transmission and reception operation may be represented by an index indicating the transmission and reception operation based on a predetermined correlation table (a correlation table of a transmission and reception operation and an index value) in order to reduce a signaling overhead. In the following description, it is assumed that the subframe type information is included in the DL control information and the SL control information.

(Physical Channel Configuration)

Next, a physical channel configuration employed in the present embodiment is described. A physical channel configuration in 5G is not determined bucket may be changed in future. Therefore, the physical channel configuration illustrated below is an example, and it is not intended that the present embodiment is limited to this.

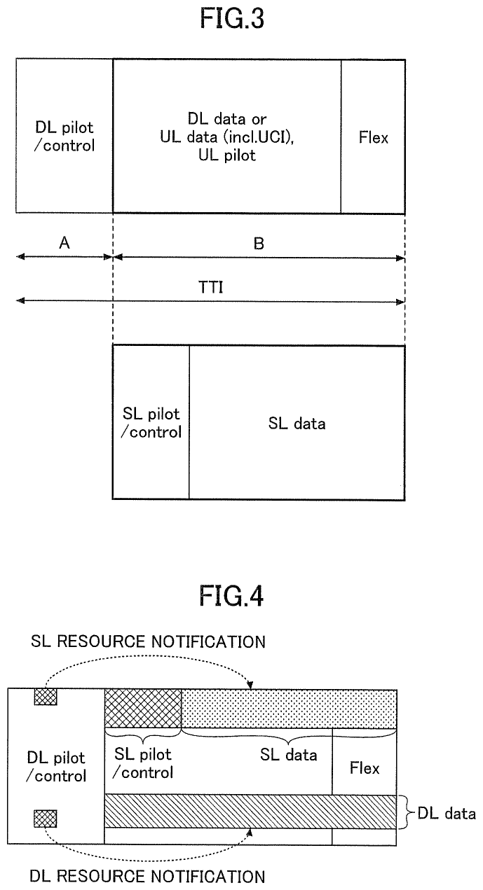

FIG. 3 is a diagram illustrating an example of a physical channel configuration discussed in 5G. As illustrated on the upper side of FIG. 3, it has been proposed that a radio frame used in 5G communication between a base station eNB and user equipment UE has an area (Area “A”) to which a downlink reference signal channel (DL Pilot) and a DL control channel (DL Control) are mapped mainly and an area (Area “B”) to which a data channel is mapped mainly so that the areas fall within 1TTI.

Although it is assumed that the vertical direction of FIG. 3 is a system band, the vertical direction is not necessarily limited to the entire system band but may be a portion of the system band. This is because 5G also discusses dividing the entire system band into a plurality of subbands and multiplexing radio frames having different TTI lengths according to frequency division multiplexing (FDM).

The DL control information transmitted in the area “A” includes various items of control information such as scheduling information and UL grant like DCI, for example.

The area “B” is further divided into a data area to which a DL data channel (DL Data) and/or a UL data channel (UL Data) is mapped and a flexible area (Flex). It is possible to switch whether the area “B” is to be used for transmission of DL data, for transmission of UL data, for transmission of DL and UL data, or exclusively for SL using the DL control information transmitted in the DL control channel.

Moreover, the flexible area can be used as a portion of the display area and can be used for transmission of ACK/NACK to DL data. Furthermore, the flexible area can be used for transmission of a reference signal and a guard period. A channel configuration in which the flexible area is not present may be used.

Since various procedures or combinations are conceivable regarding a configuration of time division multiplexing (TDM) of a plurality of signals (channels), the invention is not necessarily limited to the procedure or combination illustrated in FIG. 3.

As illustrated in on the lower side of FIG. 3, it is discussed that the SL physical channel is mapped to the area “B” of the physical channel configuration of 5G. For example, a physical channel configuration in which a SL reference signal channel (SL Pilot) and a SL control channel (SL control) are mapped to the former-half symbol of a symbol corresponding to the area “B” and a SL data channel (SL data) is mapped to the latter-half symbol is discussed.

The SL physical channel may be mapped so as to avoid the flexible area of the area “B” and the SL physical channel may be mapped so as to include the flexible area. Moreover, the SL physical channel may be mapped to the entire area “A” and the entire area “B”. In order to freely change a starting symbol in a subframe from which the SL physical channel starts, the location of the starting symbol to which the SL physical channel is mapped among a plurality of symbols in the subframe may be set to the user equipment UE via notification information or pre-configuration and may be dynamically switched using DL control information. In the latter case, it is possible to dynamically change the symbol location from which the sidelink physical channel starts according to a data amount of the DL control information.

(Frequency Multiplexing Method)

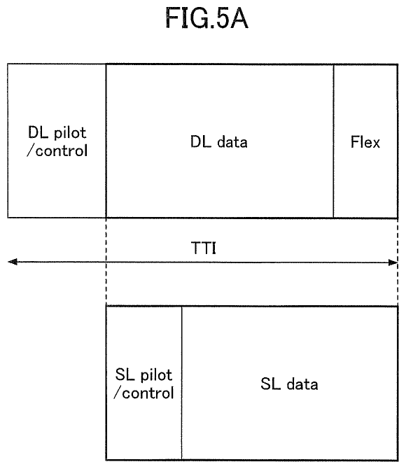

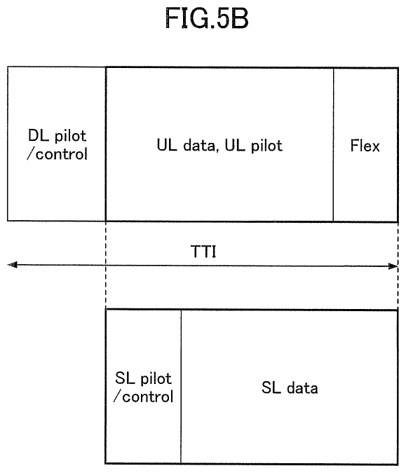

In the present embodiment, it is assumed that the SL signal and the DL signal or the UL signal are transmitted in a frequency-multiplexed manner in the same TTI outside a SL-dedicated subframe to be described later. FIG. 4 illustrates a state in which a SL signal and a DL signal are frequency-multiplexed in the same TTI. The resource location in the frequency direction of each signal is instructed via the DL control information.

(Subframe Type)

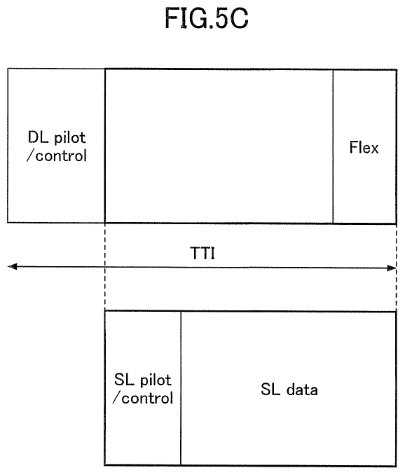

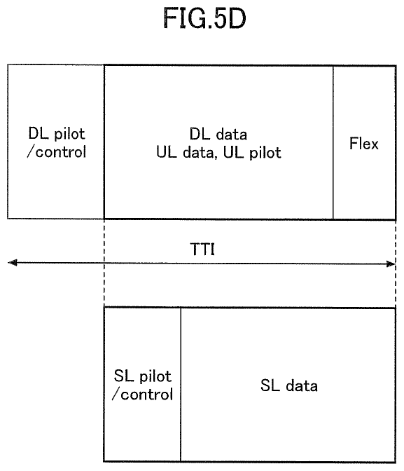

FIG. 5 is a diagram for describing an example of a subframe type. FIG. 5A illustrates a DL subframe, FIG. 5B illustrates a UL subframe, FIG. 5C illustrates a SL-dedicated subframe (that is, a subframe to which a SL resource only can be allocated), and FIG. 5D illustrates a subframe in which DL and UL are present together. Although FIG. 5 illustrates four subframe types, the number of subframe types is not limited to 4. For example, the DL subframe may be further divided into a plurality of subframe types due to a difference in a mapping method of reference signals mapped to a DL data channel. The UL subframe, the SL-dedicated subframe, and the subframe in which DL and UL are present together may be similarly divided into a plurality of subframe types.

(SL Signal Resource Mapping Configuration)

Next, a “SL signal resource mapping configuration” which is a portion of the transmission and reception operation is described. When the subframe type is the DL subframe, a configuration in which a specific reference signal is mapped to a partial portion or an entire portion of the DL data channel is considered. The specific reference signal is meant to indicates a reference signal or a synchronization signal (in other words, a reference signal different from a reference signal used for demodulation of DL data like DM-RS) which is transmitted regardless of DL data, such as a reference signal (for example, CRS/CSI-RS) used for measurement of radio quality (CSI: Channel State Information) or a reference signal used for selecting a beam.

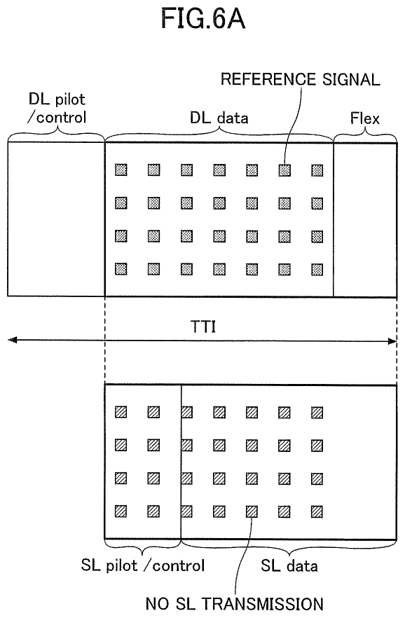

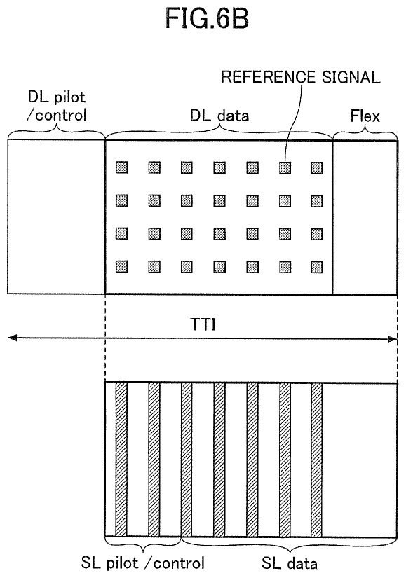

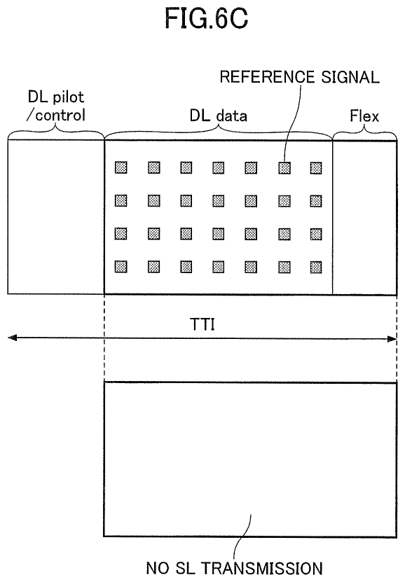

When the subframe type is a DL subframe and the specific reference signal is a subframe which is mapped to a partial portion or an entire portion of a DL channel, the user equipment UE does not transmit a SL signal using a resource to which the specific reference signal is mapped in order to protect the specific reference signal. FIG. 6A illustrates an example in which SL signals are not transmitted in units of REs (Resource elements), and FIG. 6B illustrates an example in which SL signals are not transmitted in units of symbols. FIG. 6C illustrates an example in which SL signals are not transmitted in the subframe. Even when notification information, control information, or the like is mapped to the subframe, the user equipment UE may not transmit SL signals using a resource (or the subframe thereof) to which the notification information, the control information, or the like is mapped. In this way, the user equipment UE that transmits SL signals can suppress the influence of interference with cellular communication.

The “SL signal resource mapping configuration” including resources that do not transmit SL signals may be defined in advance as standard specifications for each subframe type, may be set to the user equipment UE via notification information or higher-layer (RRC) signaling, and may be pre-configured via a core network, SIM, or the like. The SL signal resource mapping configuration set to the user equipment UE may be explicitly represented by a specific resource location and may be represented by an index indicating the resource location based on a predetermined correlation table (a correlation table of a resource mapping configuration and an index value). In the latter case, it is possible to reduce a signaling overhead.

[Notification Example of SL Signal Resource Mapping Configuration]

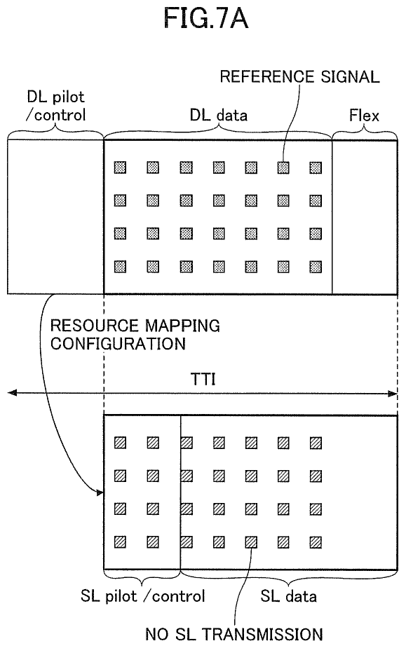

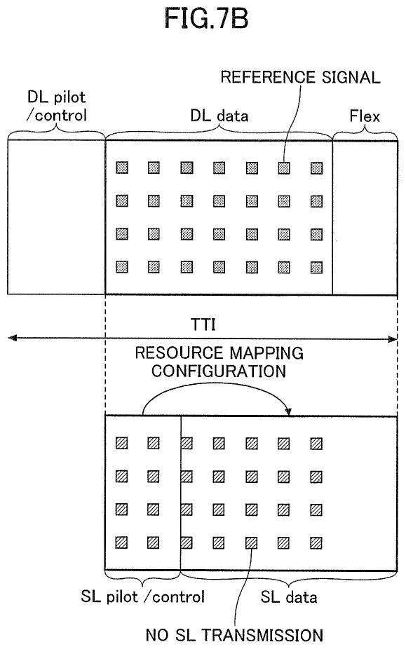

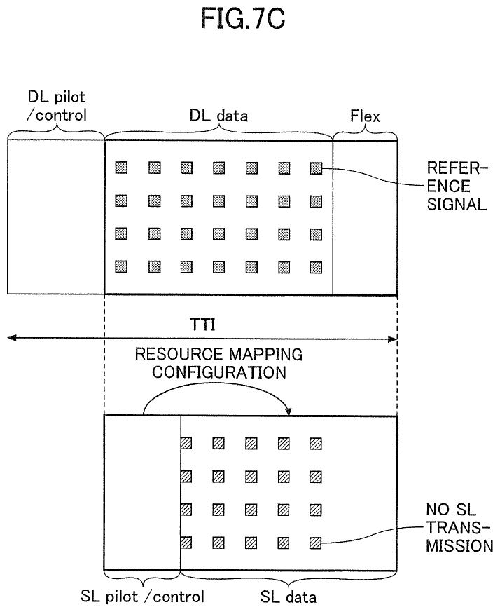

FIG. 7A illustrates an example in which the “SL signal resource mapping configuration” is notified from a base station eNB to a transmission-side user equipment UE and a reception-side user equipment UE via subframe type information included in the DL control information. In the example of FIG. 7A, the “SL signal resource mapping configuration” of both a SL control channel and a SL data channel can be notified to the user equipment UE.

FIGS. 7B and 7C illustrate examples in which the “SL signal resource mapping configuration” is notified from a transmission-side user equipment UE to a reception-side user equipment UE via subframe type information included in the SL control information. In the examples of FIGS. 7B and 7C, the “SL signal resource mapping configuration” of the SL data channel can be notified to the user equipment UE. In the case of FIG. 7B, unlike FIG. 7C, the reception-side user equipment UE needs to know the SL signal resource mapping configuration in a SL control channel in advance by a certain method (for example, using the subframe type information or the like included in the DL control information) in order to receive a SL signal in the SL control channel. On the other hand, in the case of FIG. 7C, the reception-side user equipment UE does not need to know the SL signal resource mapping configuration in advance when receiving a SL signal in the SL control channel.

In the case of FIGS. 7A and 7B, the transmission-side user equipment UE can apply rate matching to both the SL control channel and the SL data channel. On the other hand, in the example of FIG. 7C, since the reception-side user equipment UE knows the SL signal resource mapping configuration at the timing of receiving the SL control information, the transmission-side user equipment UE can apply rate matching to the SL data channel only.

The user equipment UE may insert information indicating the SL signal resource mapping configuration in the SL control information in addition to (or instead of) the subframe type information. In this case, the SL signal resource mapping configuration may be represented by an index indicating the resource location based on a predetermined correlation table (a correlation table of a resource mapping configuration and an index value). Moreover, the SL signal resource mapping configuration may be represented using resource allocation information included in the SL control information and may be implicitly represented in correlation with a SL signal transmission mode or the like included in the SL control information. In this way, it is possible to avoid an increase in overhead of a signaling message.

As described above, in the present embodiment, the SL control information may be directly transmitted from the base station eNB to the user equipment UE. The base station eNB can notify the “SL signal resource mapping configuration” to the transmission-side user equipment UE and the reception-side user equipment UE present in an adjacent cell as well as the subject cell.

It may be switched whether or not to perform an operation of preventing a SL signal from being performed using a resource to which a specific reference signal is mapped using notification information or upper-layer (RRC) signaling. When the operation of preventing a SL signal from being performed is performed, the user equipment UE may transmit the SL signal according to a predetermined SL signal resource mapping configuration regardless of the subframe type.

[Protection of Reference Signal of Adjacent Cell]

Although the “SL signal resource mapping configuration” described above is correlated with the subframe type of the subject cell, the subject cell and the adjacent cell may have different subframe types. In this case, particularly, when a SL signal is transmitted at a cell end, the SL signal may interfere with a reference signal transmitted in a subframe on an adjacent cell.

Therefore, in order to protect a specific reference signal transmitted in an adjacent cell in addition to a subject cell, a SL signal may not be transmitted in a resource to which a specific reference signal is mapped in at least any one of the subject cell and the adjacent cell.

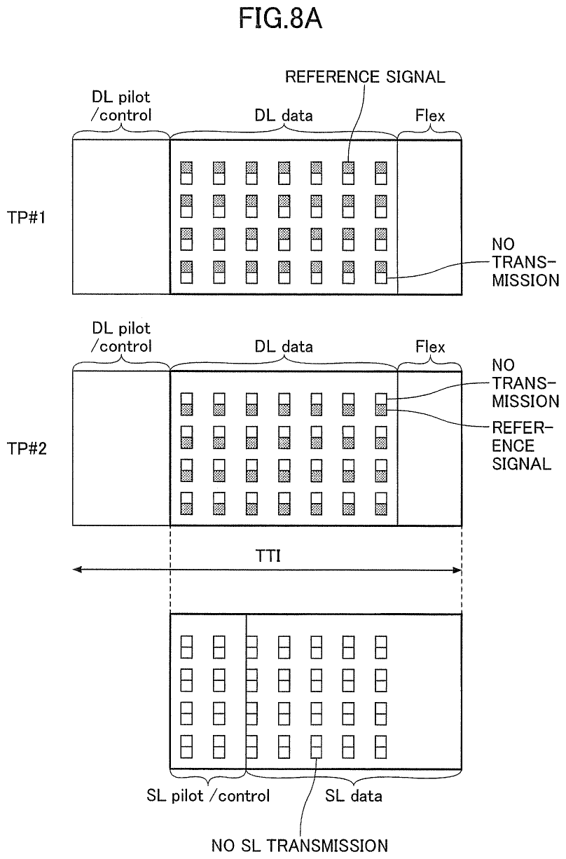

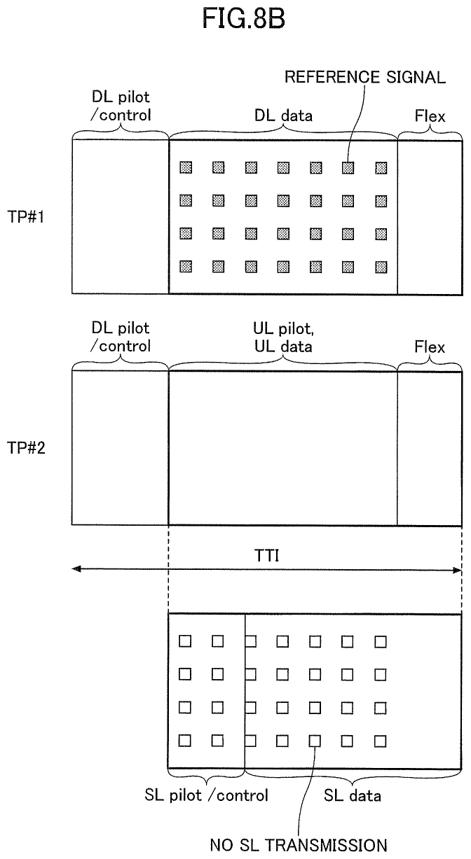

FIG. 8A illustrates an example in which, when the resource locations of the specific reference signal transmitted at two transmission points (the same meaning as two cells) of Transmission Point (TP)#1 and TP #2 are different, the user equipment UE does not transmit a SL signal using resources to which the specific reference signals at two transmission points are mapped. FIG. 8B illustrates a case in which, when a specific reference signal is transmitted at only one transmission point of TP #1 and TP #2, the user equipment UE does not transmit a SL signal using a resource to which the specific reference signal is mapped. In the examples of FIGS. 8A and 8B, it is assumed that the user equipment UE is present in any one of the cells on TP #1 and TP #2 and the other user equipment UE is present in an adjacent cell.

It is assumed that the subframe type of the subject cell and the subframe type of the adjacent cell do not change in an interlocked manner but change independently. Therefore, the subframe type of the subject cell may be defined according to a combination pattern between the subframe type of the subject cell and the subframe type of the adjacent cell in order to allow the user equipment UE to know the “SL signal resource mapping configuration” which takes the subframe type of the adjacent cell into consideration using the subframe type of the subject cell. The “SL signal resource mapping configuration” which takes the subframe type of the adjacent cell into consideration may be defined in advance as standard specifications for each subframe type defined according to the combination pattern, may be set to the user equipment UE via notification information or higher-layer (RRC) signaling, and may be pre-configured via a core network, SIM, or the like. Moreover, the base station eNB may insert the subframe type for indicating the “SL signal resource mapping configuration” and the subframe type for indicating a transmission and reception operation other than the “SL signal resource mapping configuration” separately in the DL control information or the SL control information.

As another method, the “SL signal resource mapping configuration” in an adjacent cell may be set to the user equipment UE in advance for each subframe type of the adjacent cell, and the base station eNB may notify the DL control information or the SL control information to the user equipment UE by inserting both the subframe type of the subject cell and the subframe type of the adjacent cell in the DL control information or the SL control information. In this case, the “SL signal resource mapping configuration” of the adjacent cell may be defined in advance as standard specifications for each subframe type, may be set to the user equipment UE via notification information or higher-layer (RRC) signaling, and may be pre-configured via a core network, SIM, or the like.

The base station eNB may directly transmit the SL control information including the subframe type information of the subject cell to the user equipment UE. In this case, the transmission-side user equipment UE and the reception-side user equipment UE present near the boundary between the subject cell and the adjacent cell can recognize the “SL signal resource mapping configuration” in each neighboring cell by receiving the subframe type information from a plurality of base stations eNBs. Moreover, the user equipment UE can prevent a SL signal from being transmitted in a resource to which the specific reference signal is mapped in at least one cell among the respective neighboring cells on the basis of the “SL signal resource mapping configuration” of the respective neighboring cells.

(Transmission Power Level Control Method when Transmitting SL Signals)

Next, a “transmission power level control method when transmitting SL signals” which is a portion of the transmission and reception operation is described. In the present embodiment, the transmission power level when transmitting a SL signal is defined in advance for each subframe type, and the user equipment UE transmits a SL signal using the transmission power level corresponding to the subframe type. Hereinafter, a specific example of a control method for controlling the transmission power level for each subframe type is described.

[DL Subframe]

A transmission power level (or a largest transmission power level) is expressed as “X” dBm (for example, 10 dBm). The value “X” is not an absolute value but may be determined by applying a predetermined offset value to the reception power level of DL.

The largest transmission power level only may be set to the user equipment UE, and the actual transmission power level may be autonomously determined by the transmission-side user equipment UE on the basis of a path loss or the like between the transmission-side user equipment UE and the reception-side user equipment UE. In this way, it is possible to reduce interference on other units of user equipment UEs.

The transmission power level may be determined by applying a predetermined offset value to the transmission power level (or the largest transmission power level) set to a subframe in which DL and UL are present together. Even when there is an interference from the DL signal, it is possible to secure a certain communication range or wider.

[Ul Subframe]

A transmission power level (or a largest transmission power level) is expressed as “Y” dBm (for example, 23 dBm). The value “Y” is not an absolute value but may be autonomously determined by the transmission-side user equipment UE on the basis of a path loss between the transmission-side user equipment UE and the base station eNB. The level of interference with UL can be optimized.

The largest transmission power level only may be set to the user equipment UE, and the actual transmission power level may be autonomously determined by the transmission-side user equipment UE on the basis of a path loss or the like between the transmission-side user equipment UE and the reception-side user equipment UE. In this way, it is possible to reduce interference on other units of user equipment UEs.

The transmission power level may be determined by applying a predetermined offset value to the transmission power level (or the largest transmission power level) set to a subframe in which DL and UL are present together. Even when there is an interference from the DL signal, it is possible to secure a certain communication range or wider.

[SL-Dedicated Subframe]

A transmission power level (or a largest transmission power level) is expressed as “Z” dBm (for example, 23 dBm). The largest transmission power level only may be set to the user equipment UE, and the actual transmission power level may be autonomously determined by the transmission-side user equipment UE on the basis of a path loss or the like between the transmission-side user equipment UE and the reception-side user equipment UE. In this way, it is possible to reduce interference on other units of user equipment UEs.

[Subframe in which DL and UL are Present Together]

The user equipment UE may control the transmission power level of a DL symbol according to the same method as the “DL subframe” and may control the transmission power level of a UL symbol according to the same method as the “UL subframe”. Alternatively, the user equipment UE may compare the transmission power level determined by the same method as the “DL subframe” and the transmission power level determined by the same method as the “UL subframe” and may apply the smaller transmission power level to the entire subframe. In the latter case, it is not necessary to switch the transmission power level for respective symbols and it is possible to simplify the circuit configuration of a transmitter.

[Supplementary Explanation]

As described above, it is assumed that the subframe type of the subject cell and the subframe type of the adjacent cell do not change in an interlocked manner but change independently. Therefore, the subframe type of the subject cell may be defined according to a combination pattern between the subframe type of the subject cell and the subframe type of the adjacent cell in order to allow the user equipment UE to know the “transmission power level control method when transmitting SL signals” which takes the subframe type of the adjacent cell into consideration using the subframe type of the subject cell. The “transmission power level control method when transmitting SL signals” which takes the subframe type of the adjacent cell into consideration may be defined in advance as standard specifications for each subframe type defined according to the combination pattern, may be set to the user equipment UE via notification information or higher-layer (RRC) signaling, and may be pre-configured via a core network, SIM, or the like. Moreover, the base station eNB may insert the subframe type for indicating the “transmission power level control method when transmitting SL signals” and the subframe type for indicating a transmission and reception operation other than the “transmission power level control method when transmitting SL signals” separately in the DL control information or the SL control information. In this way, it is possible to perform interference control according to the subframe type of the adjacent cell. Moreover, even when the subject cell is operated using an SL-dedicated carrier, interference control can be performed according to the subframe type of the adjacent cell.

By inserting the subframe type or the transmission power level to the SL control information, the reception-side user equipment UE can perform CSI measurement of the SL signal for each subframe type.

(SL Signal Transmission Timing)

Next, the “SL signal transmission timing” which is a portion of the transmission and reception operation is described. In the present embodiment, the SL signal transmission timing is defined in advance for each subframe type, and the user equipment UE transmits SL signals at a transmission timing corresponding to the subframe type.

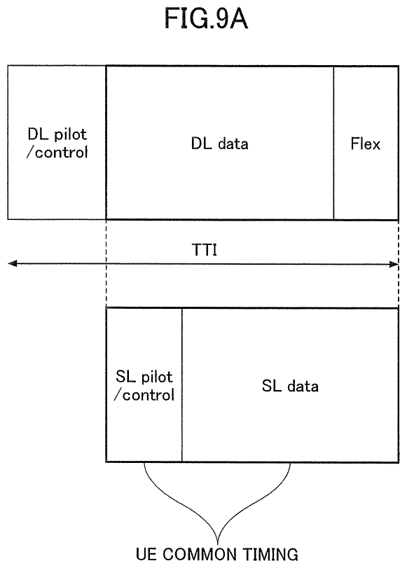

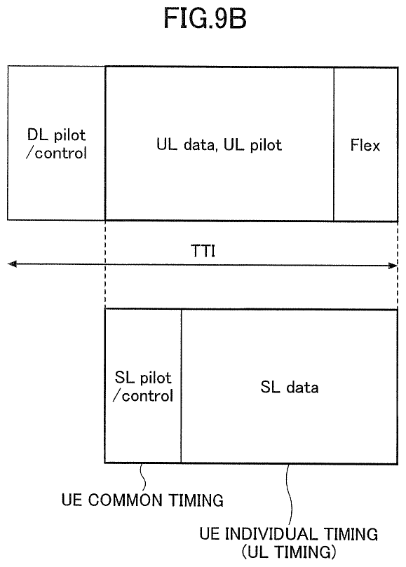

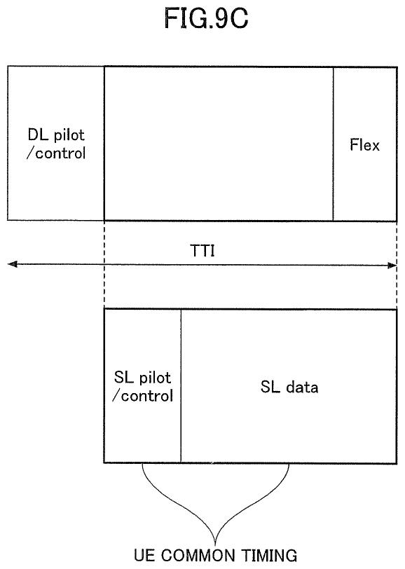

FIG. 9A illustrates an example of a SL signal transmission timing in a DL subframe, FIG. 9B illustrates an example of a SL signal transmission timing in a UL subframe, and FIG. 9C illustrates an example of a SL signal transmission timing in a SL-dedicated subframe. In FIGS. 9A to 9C, “UE common timing” may be a synchronization timing (DL synchronization timing) with a synchronization signal transmitted from the base station eNB and may be a synchronization timing between Global Navigation Satellite System (GNSS) or the like, for example.

As illustrated in FIG. 9B, when the transmission timing of SL data is different from the transmission timing of SL control information (SL control), the user equipment UE may explicitly insert the transmission timing (UL transmission timing) of the SL data to the SL control information. Since the UL transmission timing (Timing Alignment (TA) value) is instructed from the eNB via a TA command according to the distance between the user equipment UE and the base station eNB, the transmission-side user equipment UE can allow the reception-side user equipment UE to recognize an appropriate reception timing.

FIGS. 9A to 9C are examples only and the present invention is not limited to this. For example, in FIGS. 9A to 9C, the SL signal transmission timings may be “UE common timing”. In this case, as described above, since it is not necessary to explicitly insert information indicating the SL data to the SL control information, it is possible to reduce a signaling overhead.

It may be defined that the subframe type capable of transmitting SL signals may be limited for the user equipment UE in which the transmission timing (TA value) of UL is not set from the base station eNB. Specifically, the user equipment UE in which the transmission timing (TA value) of UL is not set from the base station eNB may not transmit the SL signal in the UL subframe (FIG. 9B).

(Guard Time Setting)

Next, the “guard time setting” which is a portion of the transmission and reception operation is described. In the present embodiment, the guard time set to the SL physical channel is defined in advance for each subframe type, and the user equipment UE sets a guard time corresponding to the subframe type and transmits the SL signal. The guard time may not necessarily be set.

For example, when a transmission timing of UL is used for transmission of SL data, the last symbol of the SL control channel may be set to the guard time for the UL subframe.

Moreover, the last symbol of the SL control channel may be set to the guard time for all types of subframe, and the last symbol of the SL data channel may be set to the guard time for the UL subframe.

The guard time is not limited to the last symbol, but an arbitrary symbol may be set to the guard time. When the guard time is limited to the last symbol of the SL control channel or the SL data channel, since the guard time corresponds to only one symbol, it is possible to reduce an overhead associated with the addition of the guard time.

The user equipment UE may explicitly include information indicating the guard time set to the SL data channel in the SL control information. By doing so, it is possible to allow the reception-side user equipment UE to recognize the guard time set to the SL data channel.

(Transmission Timing of DL Control Information for Notifying Subframe Type)

The base station eNB may transmit DL control information for notifying the subframe type using the first half (for example, the starting symbol or the like) of the DL control channel. In this way, the user equipment UE can recognize the subframe type by monitoring the symbol in the first half of the DL control channel.

In this way, when the user equipment UE is in the DRX state or the RRC IDLE state, the user equipment UE only needs to monitor the limited symbol only, it is possible to reduce power consumption.

In this way, the user equipment UE having recognized the SL-dedicated subframe can immediately start a process (for example, coding of messages to be transmitted and switching of a Radio Frequency (RF) circuit) for transmitting SL signals and to quickly perform transmission of SL signals. Such an operation may be realized by allowing the subframe type notified via the DL control channel to indicate the subframe type of a TTI different from the DL control channel.

(SL-Dedicated Carrier)

In SL, it is possible to set carriers used exclusively for SL. In SL-dedicated carriers, since transmission of DL and UL is not performed, it is not necessary to perform the above-described operations (notification of the subframe type, setting of the transmission and reception operation, and the like).

Therefore, the user equipment UE may perform transmission of SL signals without performing an operation of recognizing the subframe type by monitoring the DL control channel in the SL-dedicated carriers.

<Functional Configuration>

A functional configuration example of the user equipment UE and the base station eNB that execute the operation of the plurality of embodiments described above is described.

(User Equipment)

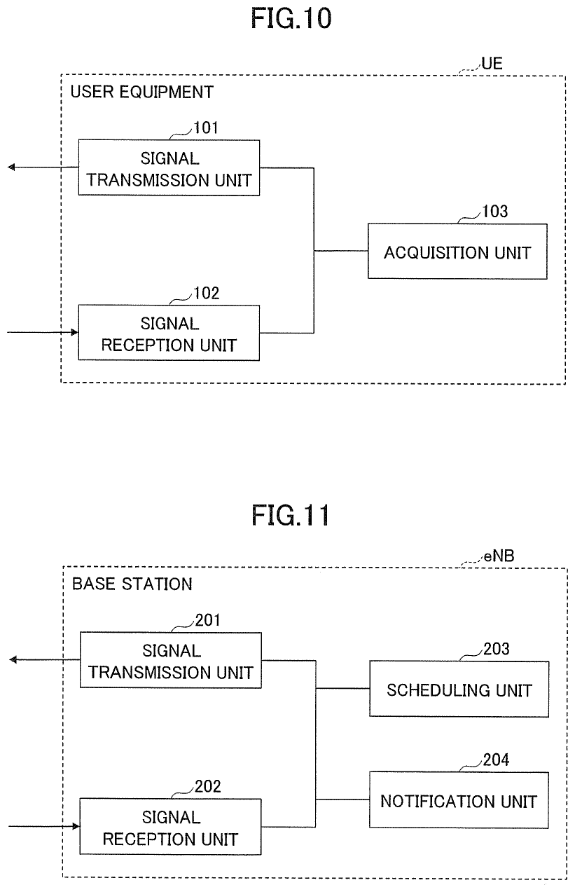

FIG. 10 is a diagram illustrating an example of a functional configuration of user equipment according to the embodiment. As illustrated in FIG. 10, the user equipment UE includes a signal transmission unit 101, a signal reception unit 102, and an acquisition unit 103. FIG. 10 illustrates functional units of the user equipment UE particularly related to the embodiment only and also includes at least functions (not illustrated) for performing operations compatible with LTE (including 5G). Moreover, the functional configurations illustrated in FIG. 10 are examples only. The functional classifications and the names of the functional units are not particularly limited as long as the operations according to the present embodiment can be executed.

The signal transmission unit 101 includes a function of generating various signals of the physical layer from higher-layer signals to be transmitted from the user equipment UE and transmitting the signals wirelessly. Moreover, the signal transmission unit 101 has a SL signal transmission function and a cellular communication transmission function. Furthermore, the signal transmission unit 101 has a function of transmitting the SL signal according to a transmission and reception operation corresponding to the subframe type notified via the type information (the subframe type information) acquired by the acquisition unit 103 when transmitting the SL signal.

The signal reception unit 102 includes a function of wirelessly receiving various signals from the other user equipment UE or the base station eNB and acquiring higher-layer signals from the received physical layer signals. Moreover, the signal reception unit 102 has a SL signal receiving function and a cellular communication receiving function. Furthermore, the signal reception unit 102 has a function of receiving the SL signal according to a transmission and reception operation corresponding to the subframe type notified via the type information acquired by the acquisition unit 103 when receiving the SL signal.

The acquisition unit 103 has a function of acquiring the type information that notifies the type of the subframe to which the SL resources are allocated. The acquisition unit 103 may acquire the type information (the subframe type information) via the DL control information and may acquire the same via the SL control information. The type of the subframe may be an uplink subframe, a downlink subframe, an SL subframe, or an uplink/downlink subframe.

The acquisition unit 103 may acquire the information that defines different transmission and reception operations for respective types of subframe from the base station eNB via notification information or higher-layer (RRC) signaling. Different transmission and reception operations may be defined for respective types of subframe. The transmission and reception operation may include an operation of transmitting the SL signal using a resource other than a predetermined resource (a resource for which mapping of SL signals is inhibited and a resource to which a reference signal of DL is mapped). Moreover, the transmission and reception operation may include an operation of transmitting the SL signal with predetermined transmission power level defined for each type of subframe. Furthermore, the transmission and reception operation may include an operation of transmitting a SL control channel signal at a transmission timing defined for each type of subframe and an operation of transmitting a SL data channel signal at a transmission timing defined for each type of subframe.

<Base Station>

FIG. 11 is a diagram illustrating a functional configuration example of a base station according to the embodiment. As illustrated in FIG. 11, the base station eNB includes a signal transmission unit 201, a signal reception unit 202, a scheduling unit 203, and a notification unit 204. FIG. 11 illustrates functional units of the base station eNB particularly related to the embodiment only and also includes at least functions (not illustrated) for performing operations compatible with LTE (including 5G). Moreover, the functional configurations illustrated in FIG. 11 are examples only. The functional classifications and the names of the functional units are not particularly limited as long as the operations according to the present embodiment can be executed.

The signal transmission unit 201 includes a function of generating various signals of the physical layer from higher-layer signals to be transmitted from the base station eNB and transmitting the signals wirelessly. The signal transmission unit 201 may have a function of transmitting a SL signal (for example, SL control information). The signal reception unit 202 includes a function of wirelessly receiving various signals from the user equipment UE and acquiring higher-layer signals from the received physical layer signals.

The scheduling unit 203 has a function of determining the subframe type and allocating radio resources for downlink, uplink, and SL.

The notification unit 204 has a function of notifying the subframe type to the user equipment UE. Moreover, the notification unit 204 has a function of notifying information that defines different transmission and reception operations for respective types of subframe to the user equipment UE via the notification information or the higher-layer (RRC) signaling.

<Hardware Configuration>

The block diagrams (FIGS. 10 and 11) used in the description of the embodiment illustrate functional blocks. These functional blocks (configuration units) are realized by an arbitrary combination of hardware and/or software. Moreover, means for realizing the respective functional blocks is not particularly limited. That is, the respective functional blocks may be realized by one apparatus which is physically and/or logically coupled and may be realized by a plurality of apparatuses which are physically and/or logically separated and which are directly and/or indirectly (for example, by cables and/or wirelessly) connected.

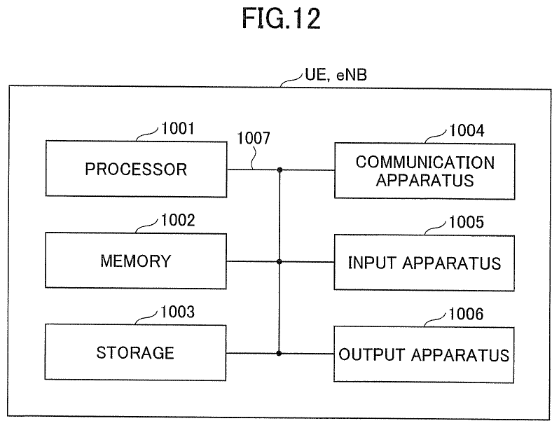

For example, the user equipment UE and the base station eNB according to an embodiment of the present invention may function as a computer that performs processing of the communication method of the present invention. FIG. 12 is a diagram illustrating an example of a hardware configuration of user equipment and a base station according to the embodiment. The user equipment UE and the base station eNB may be physically configured as a computer apparatus which includes a processor 1001, a memory 1002, a storage 1003, a communication apparatus 1004, an input apparatus 1005, an output apparatus 1006, a bus 1007, and the like.

In the following description, the wording “apparatus” may be replaced with circuit, device, unit, or the like. The hardware configuration of the user equipment UE and the base station eNB may include one or a plurality of apparatuses illustrated in the drawings and may not include some apparatuses.

The respective functions of the user equipment UE and the base station eNB are realized when predetermined software (program) is read onto hardware such as the processor 1001, the memory 1002, and the like, the processor 1001 performs an operation, and the communication by the communication apparatus 1004 and the data read and/or write in the memory 1002 and the storage 1003 are controlled.

The processor 1001 operates an operating system to control the entire computer, for example. The processor 1001 may be configured as a central processing unit (CPU) that includes an interface to a peripheral apparatus, a control apparatus, an operation apparatus, a register, and the like. For example, the signal transmission unit 101, the signal reception unit 102, and the acquisition unit 103 of the user equipment UE and the signal transmission unit 201, the signal reception unit 202, the scheduling unit 203, and the notification unit 204 of the base station eNB may be realized by the processor 1001.

The processor 1001 reads a program (program codes), a software module, or data from the storage 1003 and/or the communication apparatus 1004 into the memory 1002 and executes various processes according to the program and the like. A program for causing a computer to execute at least a portion of the operations described in the embodiment is used as the program. For example, the signal transmission unit 101, the signal reception unit 102, and the acquisition unit 103 of the user equipment UE and the signal transmission unit 201, the signal reception unit 202, the scheduling unit 203, and the notification unit 204 of the base station eNB may be realized by a control program which is stored in the memory 1002 and operated by the processor 1001. Moreover, the other functional blocks may be realized by the processor. Although it has been described that the above-described processes are executed by one processor 1001, the processes may be executed by two or more processors 1001 simultaneously or sequentially. One or more chips may be mounted in the processor 1001. The program may be transmitted from a network via a telecommunication circuit.

The memory 1002 is a computer-readable recording medium and may be configured by at least one of a Read Only Memory (ROM), an Erasable Programmable ROM (EPROM), an Electrically Erasable Programmable ROM (EEPROM), a Random Access Memory (RAM), and the like, for example. The memory 1002 may be referred to as a register, a cache, a main memory (main storage device), and the like. The memory 1002 can store a program (program codes), a software module, and the like that can be executed to perform a communication method according to an embodiment of the present invention.

The storage 1003 is a computer-readable recording medium and may be configured by at least one of an optical disc such as a Compact Disc ROM (CD-ROM), a hard disk drive, a flexible disk, an optomagnetic disc (for example, a compact disc, a digital versatile disc, or a Blu-ray (registered trademark) disc), a smartcard, a flash memory (for example, a card, stick, or a key drive), a floppy (registered trademark) disk, a magnetic strip, and the like, for example. The storage 1003 may be referred to as an auxiliary storage apparatus. The above-descried storage medium may be an appropriate medium other than a database and a server that include the memory 1002 and/or the storage 1003.

The communication apparatus 1004 is hardware (transmission and reception device) for performing communication between computers via cables and/or a wireless network and is also referred to as a network device, a network controller, a network card, a communication module, and the like, for example. For example, the signal transmission unit 101 and the signal reception unit 102 of the user equipment UE and the signal transmission unit 201 and the signal reception unit 202 of the base station eNB may be realized by the communication apparatus 1004.

The input apparatus 1005 is an input device (for example, a keyboard, a mouse, a microphone, a switch, a button, a sensor, and the like) that receives the input from the outside. The output apparatus 1006 is an output device (for example, a display, a speaker, an LED lamp, and the like) that outputs information to the outside. The input apparatus 1005 and the output apparatus 1006 may have an integrated configuration (for example, a touch panel).

The respective apparatuses such as the processor 1001 and the memory 1002 are connected by the bus 1007 for communicating information. The bus 1007 may be configured by a single bus and may be configured by different buses for respective apparatuses.

The user equipment UE and the base station eNB may be configured to include hardware such as a microprocessor, a digital signal processor (DSP: Digital Signal Processor), an Application Specific Integrated Circuit (ASIC), a Programmable Logic Device (PLD), an Field Programmable Gate Array (FPGA), and the like, and part or all of the respective functional blocks may be implemented by the hardware. For example, the processor 1001 may be implemented by at least one of these items of hardware.

### CONCLUSION

According to the embodiment, there is provided user equipment of a radio communication system that supports a plurality of types of subframes that can be configured to be any of an uplink, a downlink, or a sidelink, the user equipment including an acquisition unit that acquires type information for notifying a type of a subframe; a transmitter that transmits a sidelink signal according to a transmission and reception operation corresponding to the subframe type notified via the type information when transmitting the sidelink signal; and a receiver that receives the sidelink signal according to a transmission and reception operation corresponding to the subframe type notified via the type information when receiving the sidelink signal. According to this user equipment UE, in a radio communication system that supports a subframe which can be configured to be used for any purpose, a technique can be provided that can reduce interference caused by an SL signal.

The type of the subframe may be any one of a uplink subframe, a downlink subframe, a sidelink subframe, and an uplink and downlink subframe, and different transmission and reception operations may be defined in advance for respective types of the subframes. As a result, different transmission and reception operations can be defined for respective types of the subframes, and interference caused by the SL signal can be appropriately reduced.

The transmission and reception operation may include an operation of transmitting the sidelink signal while avoiding a predetermined resource. As a result, interference occurring between the SL signal and the reference signal transmitted via DL can be avoided.

The transmission and reception operation may include an operation of transmitting the sidelink signal with a transmission power level defined in advance for each type of the subframe. As a result, the transmission power of the SL signal can be controlled for each subframe type, and interference caused by the SL signal can be reduced.

The transmission and reception operation may include an operation of transmitting a sidelink control channel signal at a transmission timing defined for each type of the subframe and an operation of transmitting a sidelink data channel signal at a transmission timing defined for each type of the subframe. As a result, the transmission timing of the SL signal can be controlled for each subframe type, and interference caused by the SL signal can be reduced.

Furthermore, according to the embodiments, there is provided a communication method executed by user equipment of a radio communication system that supports a plurality of types of subframes that can be configured to be any of an uplink, a downlink, or a sidelink, the communication method including: acquiring type information for notifying a type of a subframe; transmitting a sidelink signal according to a transmission and reception operation corresponding to the subframe type notified via the type information when transmitting the sidelink signal; and receiving the sidelink signal according to a transmission and reception operation corresponding to the subframe type notified via the type information when receiving the sidelink signal. According to this communication method, in a radio communication system that supports a subframe which can be configured to be used for any purpose, a technique can be provided that can reduce interference caused by an SL signal.

### Supplementary Explanation of Embodiment

As described above, the configurations of the devices described in the embodiments of the present invention may be implemented such that a program is executed by a CPU (processor) in a device having the CPU and a memory, may be a configuration implemented by hardware such as a hardware circuit equipped with a processing logic described in the present embodiment, or may be a combination of a program and hardware.

The embodiments of the present invention are described above, but the disclosed invention is not limited to the above embodiments, and those skilled in the art would appreciate various modified examples, revised examples, alternative examples, substitution examples, and so forth. In order to facilitate understanding of the invention, specific numerical value examples are used for description, but the numerical values are merely examples, and certain suitable values may be used unless as otherwise stated. The classification of items in the above description is not essential to the present invention. Matters described in two or more items may be combined and used as necessary, and a matter described in one item may be applied to a matter described in another item (provided that they do not contradict). The boundary between functional units or processing units in a functional block diagram does not necessarily correspond to the boundary between physical parts. Operations of a plurality of functional units may be performed physically by one component, or an operation of one functional unit may be physically performed by a plurality of parts. For the sake of convenience of processing description, the base station and the mobile station are described using the functional block diagrams, but such devices may be implemented by hardware, software, or a combination thereof. Software executed by the processor included in the base station according to the embodiment of the present invention and software executed by the processor included in the mobile station according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

The subframe may further include one or a plurality of slots in a time region. The slot may further include one or a plurality of symbols (OFDM symbols, SC-FDMA symbols, and the like) in the time region.

The subframe, the slot, and the symbol indicate a time unit when transmitting signals. The subframe, the slot, and the symbol may be referred to as other names, respectively.

The shortest time unit of scheduling may be referred to as TTI. For example, one subframe may be referred to as TTI, a plurality of successive subframes may be referred to as TTI, and one slot may be referred to as TTI.

Notification of information is not limited the aspect and the embodiment described in the present specification but may be performed by other methods. For example, notification of information may be performed via physical layer signaling (for example, Downlink Control Information (DCI) or Uplink Control Information (UCI)), upper-layer signaling (for example, Radio Resource Control (RRC) signaling, Medium Access Control (MAC) signaling, notification information (Master Information Block (MIB)), or System Information Block (SIB)), other signals, or by a combination thereof. Moreover, the RRC signaling may be referred to as a RRC message, and may be an RRC Connection Setup message, a RRC Connection Reconfiguration message, or the like, for example.

The respective aspects/embodiments described in the present embodiment may be applied to Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), a system which uses other appropriate systems, and/or a next-generation system which is extended on the basis of these systems.

Since various channels and information elements can be identified by appropriate names, various names allocated to these various channels and information elements are not limited in any respect.

Input and output Information and the like may be stored in a specific location (for example, a memory) and may be managed by a management table. The input and output information and the like may be overwritten, updated, or rewritten. The output information and the like may be erased. The input information and the like may be transmitted to other apparatuses.

The user equipment UE may also be referred to by those skilled in the art as a subscriber station, a mobile station, a subscriber unit, a mobile unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terms.

The reference signal may be abbreviated as Reference Signal (RS) and may be referred to as a pilot depending on the applied standards.

The expression “on the basis of” used in the present specification does not mean “on the basis of only” unless otherwise stated particularly. In other words, the expression “on the basis of” means both “on the basis of only” and “on the basis of at least”.

To the extent that the expressions “including” and “comprising” and variants thereof are used either in the present specification or the claims, these expressions are intended to be inclusive in a manner similar to the expression “having.” Furthermore, the expression “or” used either in the present specification or the claims is not intended to mean “Exclusive-OR”.

Determination or decision may be made by a value (0 or 1) represented by one bit, may be made by a Boolean value (true or false), and may be made by comparison of numerical values (comparison with a predetermined value, for example).

Note that the terms described in this specification and/or terms required for understanding the specification may be replaced with terms having the same or similar meanings. For example, a channel and/or a symbol may be a signal (signal). Furthermore, a signal may be a message.

Each aspect/embodiment described in the specification may be used alone; may be used in combination; or may be used by switching depending on execution. Furthermore, reporting of predetermined information (e.g., reporting of “being X”) is not limited to the method of explicitly performing, and may be performed implicitly (e.g., not perform reporting of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The orders in the processing procedures, the sequences, etc., described in the aspects/embodiments described in the present specification may be switched, provided that there is no contradiction. For example, in the method described in the present specification, the elements of various steps are illustrated in an exemplary order, and the the method is not limited to the illustrated specific order.

Reporting of predetermined information (e.g., reporting of “being X”) is not limited to the method of explicitly performing, and may be implicitly performed (e.g., reporting of the predetermined information is not performed).

The information, signals, etc., described in the specification may be represented by using any of a variety of different techniques. For example, the data, indication, command, information, signal, bit, symbol, chip, etc., may be represented by a voltage, an electric current, an electromagnetic wave, a magnetic field or magnetic particles, a light field or photons, or any combination thereof.

While the present invention is described above in detail using the embodiment, it is apparent to those skilled in the art that the present invention is not limited only to the embodiments described in this specification. The present invention can also be embodied in other modified and altered embodiments without departing from the gist and scope of the present invention as defined in the appended claims. It is therefore to be understood that the disclosure of this specification is intended for the purpose of description and exemplification but is not intended to limit the scope of the invention.

This international patent application is based on and claims priority to Japanese Patent Application No. 2016-109547 filed on May 31, 2016, and the entire content of Japanese Patent Application No. 2016-109547 is incorporated herein by reference.

### LIST OF REFERENCE SYMBOLS

UE User equipment
eNB Base station
101 Signal transmission unit
102 Signal reception unit
103 Acquisition unit
201 Signal transmission unit
202 Signal reception unit
203 Scheduling unit
204 Notification unit
1001 Processor
1002 Memory
1003 Storage
1004 Communication apparatus
1005 Input apparatus
1006 Output apparatus

1. User equipment of a radio communication system that supports a plurality of types of subframes that can be configured to be any of an uplink, a downlink, or a sidelink, the user equipment comprising:
an acquisition unit that acquires type information for notifying a type of a subframe;
a transmitter that transmits a sidelink signal according to a transmission and reception operation corresponding to the subframe type notified via the type information when transmitting the sidelink signal; and
a receiver that receives the sidelink signal according to the transmission and reception operation corresponding to the subframe type notified via the type information when receiving the sidelink signal.

2. The user equipment according to claim 1,
wherein the type of the subframe is any one of a uplink subframe, a downlink subframe, a sidelink subframe, and an uplink and downlink subframe, and
wherein different transmission and reception operations are defined in advance for the respective types of the subframes.

3. The user equipment according to claim 1, wherein the transmission and reception operation includes an operation of transmitting the sidelink signal while avoiding a predetermined resource.

4. The user equipment according to claim 1, wherein the transmission and reception operation includes an operation of transmitting the sidelink signal with a transmission power level defined in advance for each type of the subframe.

5. The user equipment according to claim 1, wherein the transmission and reception operation includes an operation of transmitting a sidelink control channel signal at a transmission timing defined for each type of the subframe and an operation of transmitting a sidelink data channel signal at a transmission timing defined for each type of the subframe.

6. A communication method executed by user equipment of a radio communication system that supports a plurality of types of subframes that can be configured to be any of an uplink, a downlink, or a sidelink, the communication method comprising:
acquiring type information for notifying a type of a subframe;
transmitting a sidelink signal according to a transmission and reception operation corresponding to the subframe type notified via the type information when transmitting the sidelink signal; and
receiving the sidelink signal according to a transmission and reception operation corresponding to the subframe type notified via the type information when receiving the sidelink signal.

7. The user equipment according to claim 2, wherein the transmission and reception operation includes an operation of transmitting the sidelink signal while avoiding a predetermined resource.

8. The user equipment according to claim 2, wherein the transmission and reception operation includes an operation of transmitting the sidelink signal with a transmission power level defined in advance for each type of the subframe.

9. The user equipment according to claim 3, wherein the transmission and reception operation includes an operation of transmitting the sidelink signal with a transmission power level defined in advance for each type of the subframe.

10. The user equipment according to claim 2, wherein the transmission and reception operation includes an operation of transmitting a sidelink control channel signal at a transmission timing defined for each type of the subframe and an operation of transmitting a sidelink data channel signal at a transmission timing defined for each type of the subframe.

11. The user equipment according to claim 3, wherein the transmission and reception operation includes an operation of transmitting a sidelink control channel signal at a transmission timing defined for each type of the subframe and an operation of transmitting a sidelink data channel signal at a transmission timing defined for each type of the subframe.

12. The user equipment according to claim 4, wherein the transmission and reception operation includes an operation of transmitting a sidelink control channel signal at a transmission timing defined for each type of the subframe and an operation of transmitting a sidelink data channel signal at a transmission timing defined for each type of the subframe.
